(19) United States
(12) Patent Application Publication
(10) Pub. No.: US 2008/0118883 A1
(43) Pub. Date: May 22, 2008

(54) DENTAL IMPRESSION TOOL, SYSTEM, AND METHOD FOR USE WITH A DECORATIVE DENTAL OVERLAY

(76) Inventor: Laurel R. Leslie-Martin, Longmont, CO (US)

Correspondence Address: THE OLLILA LAW GROUP LLC, 2060 BROADWAY, SUITE 300, BOULDER, CO, 80302, US

(21) Appl. No.: 11/562,206

(22) Filed: Nov. 21, 2006

(51) Int. Cl. A61C 3/00

(52) U.S. Cl. 433/4

(57) ABSTRACT

A dental impression system is provided. The system includes a decorative dental overlay shaped to fit over one or more teeth of a person and a dental impression tool for creating a decorative impression in the overlay. The tool includes a first tool portion including a first jaw portion, a first grip portion, and a first pivot aperture located between the first jaw portion and the first grip portion, the first jaw portion including a projection. The tool further includes a second tool portion including a second jaw portion, a second grip portion, and a second pivot aperture located between the second jaw portion and the second grip portion, the second jaw portion including a depression that substantially matches the projection. The tool further includes a pivot member that passes through the first and second pivot apertures and pivotally affixes the first tool portion to the second tool portion.

### BACKGROUND OF THE INVENTION

1. Field of the Invention

The present invention relates to a dental impression tool, system, and method for use with a decorative dental overlay.

2. Statement of the Problem

There are many ways in which people express their individuality. People like to adorn and decorate themselves. They buy jewelry, dye their hair, paint their nails, etc. In addition, people change or repair their teeth in order to improve their appearance.

Dental procedures are available that can be cosmetic, can be required for medical reasons, or both. One cosmetic procedure that people obtain when they have crooked or misaligned teeth comprises an orthodontic procedure that realigns and repositions individual teeth. New developments in orthodontic technology include dental overlay devices that fit over existing teeth. Some can even exert aligning forces on the teeth.

A retainer device is a shell that is worn to keep teeth from moving out of a desired position. For example, after a successful alignment procedure, a retainer device may be worn for some time to ensure that the newly aligned teeth do not move back toward a previous configuration. Newer dental technology employs a clear retainer shell, like the aligner device, but without features that force the teeth to move.

A dental overlay shell is typically created by taking an impression of the subject's teeth. The impression is used to cast a mold of the subject's teeth. The mold is then used to form the dental overlay device. The dental overlay can be formed using conventional methods, such as thermoforming, wherein a polymer is heated and correspondingly pulled over the cast of the patient's teeth until the material matches the size and placement of the patient's teeth. The formed dental overlay shell fits substantially over the patient's existing teeth.

In the prior art, a dental overlay device is employed for purely mechanical purposes, i.e., for moving teeth to new positions and for retaining teeth in desired positions. However, these dental devices present opportunities to provide individualized aesthetic capabilities.

### SUMMARY OF THE SOLUTION

A dental impression system is provided according to an embodiment of the invention. The dental impression system comprises a decorative dental overlay shaped to fit over one or more teeth of a person and a dental impression tool for creating a decorative impression in the decorative dental overlay. The dental impression tool comprises a first tool portion including a first jaw portion, a first grip portion, and a first pivot aperture located between the first jaw portion and the first grip portion, the first jaw portion including a projection. The dental impression tool further comprises a second tool portion including a second jaw portion, a second grip portion, and a second pivot aperture located between the second jaw portion and the second grip portion, the second jaw portion including a depression that substantially matches the projection. The dental impression tool further comprises a pivot member that passes through the first and second pivot apertures and pivotally affixes the first tool portion to the second tool portion.

A dental impression tool for use with a decorative dental overlay is provided according to an embodiment of the invention. The dental impression tool comprises a first tool portion including a first jaw portion, a first grip portion, and a first pivot aperture located between the first jaw portion and the first grip portion, the first jaw portion including a first socket, and a removable projection insert including a projection. The projection insert is configured to fit into the first socket. The dental impression tool further comprises a second tool portion including a second jaw portion, a second grip portion, and a second pivot aperture located between the second jaw portion and the second grip portion, the second jaw portion including a second socket, and a removable aperture insert including a depression that substantially matches the projection. The depression insert is configured to fit into the second socket. The dental impression tool further comprises a pivot member that passes through the first and second pivot apertures and pivotally affixes the first tool portion to the second tool portion.

A dental impression tool for use with a decorative dental overlay is provided according to an embodiment of the invention. The dental impression tool comprises a first tool portion including a first jaw portion, a first grip portion, and a first pivot aperture located between the first jaw portion and the first grip portion, the first jaw portion including a projection. The dental impression tool further comprises a second tool portion including a second jaw portion a second grip portion, and a second pivot aperture located between the second jaw portion and the second grip portion, the second jaw portion including a depression that substantially matches the projection. The dental impression tool further comprises a pivot member that passes through the first and second pivot apertures and pivotally affixes the first tool portion to the second tool portion. The dental impression tool further comprises a biasing member positioned between the first tool portion and the second tool portion. The biasing member is operable to move the first jaw portion and the second jaw portion apart in an absence of a compression force on the first and second grip portions.

A method of forming a decorative impression in a decorative dental overlay is provided according to the invention. The method comprises placing a portion of the decorative dental overlay between a pair of jaws of a dental impression tool. The dental impression tool includes a first jaw portion and a projection formed thereon and a second jaw portion and a corresponding depression formed therein. The method further comprises compressing the portion of the decorative dental overlay between the projection and the depression without requiring heating of the decorative dental overlay. The compressing substantially deforms the portion of the decorative dental overlay and creates the decorative impression.

### DESCRIPTION OF THE DRAWINGS

The same reference number represents the same element on all drawings. It should be understood that the drawings are not necessarily to scale.

FIG. 1 shows a dental punch tool according to an embodiment of the invention.

FIG. 2 shows the dental punch tool in use with a dental overlay according to an embodiment of the invention.

FIG. 3 shows the dental overlay.

FIG. 4 shows the dental overlay including a decorative impression according to an embodiment of the invention.

FIG. 5 shows the dental punch tool according to an embodiment of the invention.

FIG. 6 shows a removable projection insert and a removable depression insert according to an embodiment of the invention.

FIG. 7 shows the dental punch tool according to an embodiment of the invention.

### DETAILED DESCRIPTION OF THE INVENTION

The present application claims benefit of U.S. provisional patent application 60/815,121, entitled “Punch tool/plier for dental overlay,” filed on Jun. 20, 2006. The provisional is herein incorporated by reference.

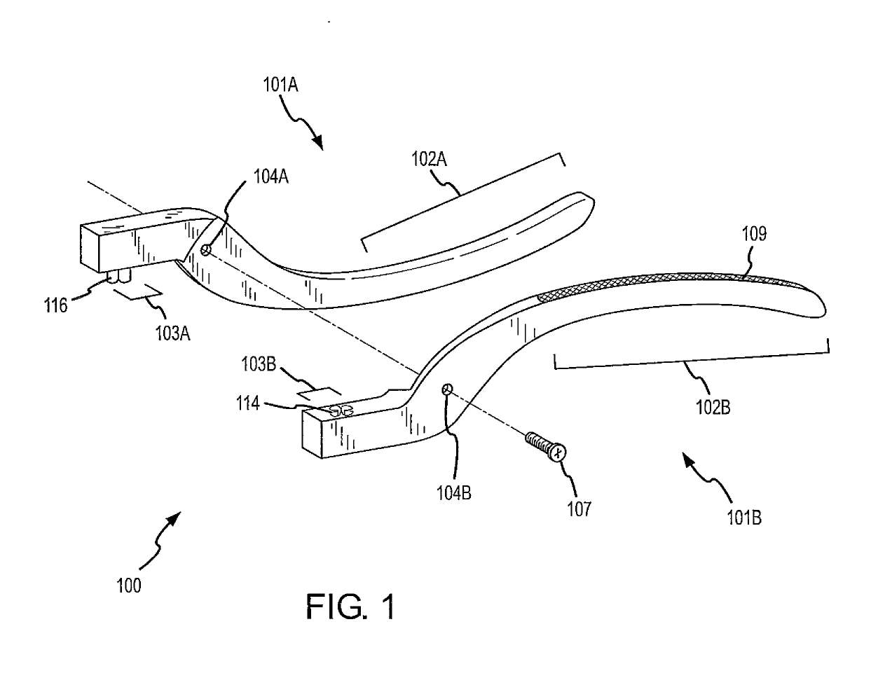

FIGS. 1-7 And the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

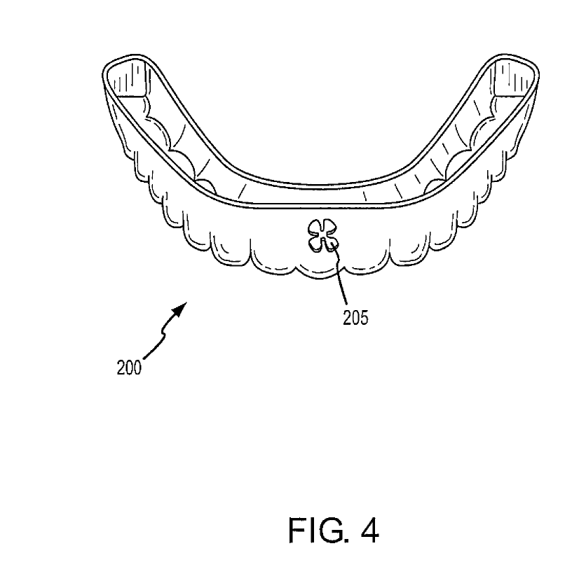

FIG. 1 shows a dental impression tool 100 according to an embodiment of the invention. The dental impression tool 100 is used for making decorative impressions or wells 205 in a decorative dental overlay 200 (see FIG. 4). The impressions 205 extend outwardly, away from the teeth of the wearer. The impressions 205 are decorative and are not made for purposes of tooth alignment. The decorative impressions 205 in the dental overlay 200 do not contact the teeth of the wearer.

The dental overlay 200 fits over at least some of the teeth of a subject and can be worn for cosmetic reasons. The dental overlay 200 can perform a decorative function for a wearer. Alternatively or in addition, the dental overlay 200 can be worn as a mouth guard or retainer device.

The dental impression tool 100 can be used to form specialized shapes, complex shapes, symbols, alphanumeric characters, punctuation characters, logos, signs, likenesses, etc. The dental impression tool 100 can create impressions including flat surfaces, curved surfaces, and/or compound shapes comprising multiple surfaces. The dental impression tool 100 can create cavities for various items, including for gemstones, jewelry, charms, etc., that can be added to or affixed to the dental overlay 200. In addition, the dental impression tool 100 can create cavities that receive paints, decals, films or appliqués, filler materials, etc.

The dental impression tool 100 comprises a first tool portion 101A, a second tool portion 101B, and a pivot pin 107. The pivot pin 107 pivotally attaches the first tool portion 101A to the second tool portion 101B. The pivot pin 107 includes a pair of heads (only one is shown) that retain the pivot pin 107 in pivot apertures 104A and 104B in the respective tool portions 101A and 101B.

The first and second grip portions 102A and 102B are designed to be gripped and squeezed. A compression force on the grip portions 102A and 102B places a closing force on the first and second jaw portions 103A and 103B. Due to the longer length of the grip portions 102A and 102B compared to the jaw portions 103A and 103B, the closing force is greater than the compression force on the grip portions 102A and 102B. This force multiplication enables a user to form impressions in various materials and form impressions in various thicknesses of materials. The impressions 205 are formed without the need for heating the dental impression tool 100.

The first and second grip portions 102A and 102B can include some manner of friction surface 109, as shown, to increase a friction between a user's hand and the dental impression tool 100. Alternatively any other manner of grooving, cross-hatching, roughening, etc., may be used to improve a user's grip on the dental impression tool 100.

The second tool portion 101B includes a depression 114 located on the second jaw portion 103B. The depression 114 in some embodiments extends partially into the second jaw portion 103B. However, in some embodiments the depression 114 can extend entirely through the second jaw portion 103B, wherein the height of the projection 116 controls the depth of an impression formed in the dental overlay 200.

The first tool portion 101A includes a corresponding projection 116 on the first jaw portion 103A. The projection 116 fits substantially closely into the depression 114 and the clearance between the projection 116 and the depression 114 is minimal, wherein the surfaces of the projection 116 cooperate with the surfaces of the depression 114. As a result, the surfaces of the projection 116 and the depression 114 cooperate to deform the dental overlay 200 and form the impression or well 205. Consequently, in use, when the two jaws are brought together, the projection 116 forces a portion of the dental overlay 200 to substantially conform to the depression 114. The impressions 205 are formed without heating the dental impression tool 100.

The projection 116 and the depression 114 can be of any desired shape. As previously discussed, an impression or well 205 can comprise any shape, including symbols, alphanumeric characters, punctuation characters, logos, signs, likenesses, etc.

The projection 116 and the depression 114 can be of any desired length and width dimensions. The projection 116 and the depression 114 can be of any desired depth, limited only by the ability of the dental overlay 200 to be deformed.

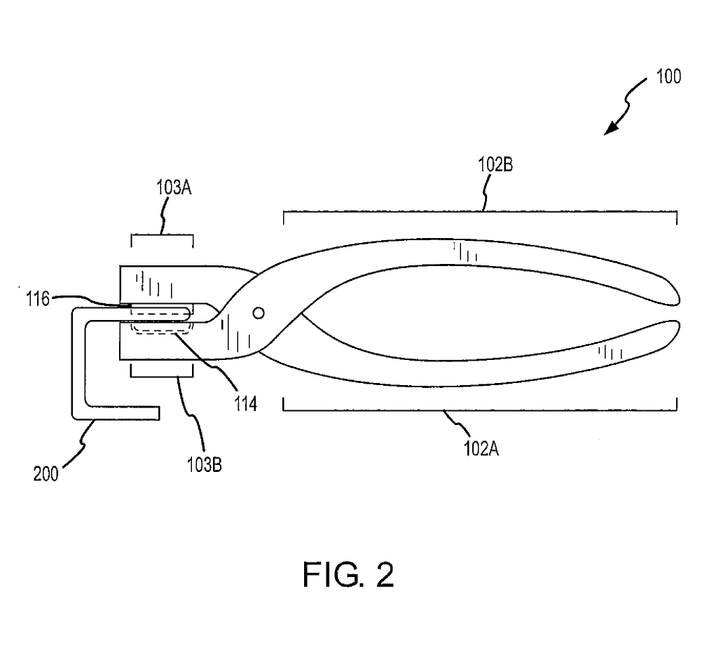

FIG. 2 shows the dental impression tool 100 in use with a dental overlay 200 according to an embodiment of the invention. In this figure, the dental impression tool 100 is being used to create an impression or well 205 in the dental overlay 200. The jaw portions 103A and 103B have been slid over the portion of the dental overlay 200. The grip portions 102A and 102B are then squeezed by the user, bringing the jaw portions 103A and 103B together. Consequently, the projection 116 forces a portion of the dental overlay 200 into the depression 114 and substantially deforms the material. The result is an impression or well 205 of substantially the same shape and dimensions as the projection 116.

In the figure, the projection 116 has pressed the material of the dental overlay 200 partially into the depression 114. It can be seen from the figure that exertion of more force will result in the projection 116 completing the deformation of the overlay material.

In the figure, the projection 116 and the depression 114 have been positioned a distance from the edge of the dental overlay 200. Consequently, the projection 116 and the depression 114 form the impression or well 205 somewhat in the middle of the dental overlay 200. However, the impression or well 205 can alternatively be formed at or near the edge of the dental overlay 200.

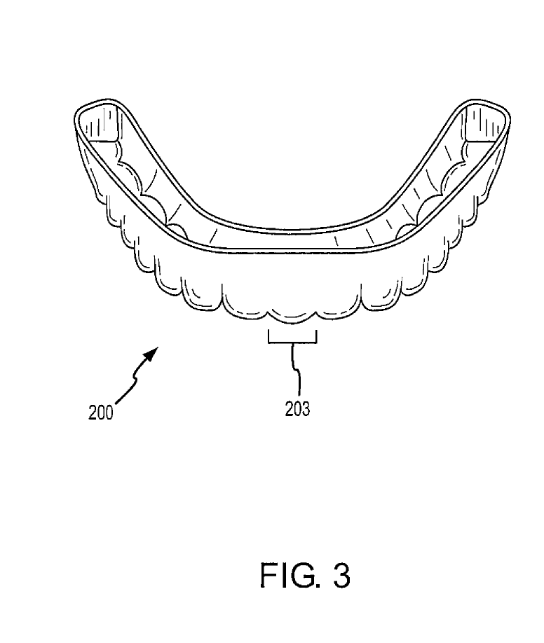

FIG. 3 shows the dental overlay 200 according to an embodiment of the invention. The dental overlay 200 is formed of a size and shape to fit over at least some of the upper or lower teeth of a patient. As a result, the dental overlay 200 can include multiple tooth chambers 203.

The dental overlay 200 is typically formed of a substantially rigid polymer. Consequently, the dental overlay 200 can provide retaining and/or support forces to at least some of the underlying teeth. The dental overlay 200 can be formed of any suitable material and can be of any required thickness. The dental overlay 200 can be transparent, translucent, opaque, or combinations thereof.

The dental overlay 200 can comprise a retainer device, for example. Alternatively, the dental overlay 200 can comprise a purely decorative/cosmetic dental appliance. A retainer device can comprise a rigid, substantially smooth and form-fitting shell that prevents teeth from moving from their current positions. The cosmetic dental appliance can merely fit over the teeth of the wearer, without placing any force on the wearer's teeth.

FIG. 4 shows the dental overlay 200 including a decorative impression 205 according to an embodiment of the invention. The decorative impression 205 is formed in the dental overlay 200 and projects or extends from the dental overlay 200. The decorative impression 205 can be formed using the dental impression tool 100, wherein the dental impression tool 100 is used to impress the decorative impression 205 into the dental overlay 200.

The decorative impression 205 can comprise a deformed portion of the dental overlay 200. The decorative impression 205 can comprise a deformed portion in combination with any manner of filling material. For example, the impression 205 can be at least partially filled with a filling, paint, film or appliqué, etc., that adds to the impression 205 and increases the visibility thereof. The decorative impression 205 can be at least partially filled with or can at least partially receive any manner of jewels, jewelry, gemstones, charms, etc. The items can be bonded to or otherwise affixed to the dental overlay 200 in any known manner.

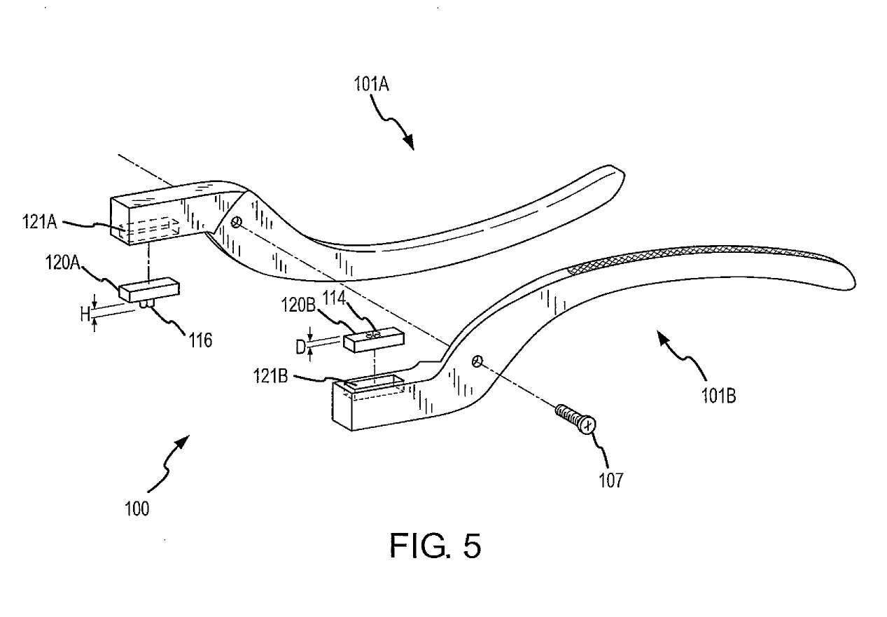

FIG. 5 shows the dental impression tool 100 according to an embodiment of the invention. In this embodiment the dental impression tool 100 includes a projection insert 120A and a depression insert 120B that are received in corresponding sockets 121A and 121B in the first and second tool portions 101A and 101B. The depression insert 120B includes the depression 114 and the projection insert 120A includes the projection 116. The projection 116 and the depression 114 can be of any shape, as previously discussed.

The depression insert 120B can include a depression 114 that passes fully through the insert 120B. Alternatively, the depression 114 can comprise a blind depression that extends only partially through the depression insert 120B. In this embodiment, the projection 116 of the projection insert 120A is of a smaller height H than the depth D of the depression 114.

The inserts 120A and 120B are removably held in the sockets 121A and 121B. The dental impression tool 100 can be manufactured with a socket of a predetermined size, and various inserts can be selected and installed into the dental impression tool 100. The removable nature of the inserts 120A and 120B therefore allows an appropriate projection/depression set to be selected and installed in the dental impression tool 100. Consequently, the dental impression tool 100 is flexible and configurable. In addition, the dental impression tool 100 can include sockets 121A and 121B that accommodate inserts of different sizes.

The inserts 120A and 120B can be held in the sockets 121A and 121B by any manner of holder device (not shown), including compressible, resilient, or spring-loaded holder devices. A holder device can further include detents, fasteners, magnetization, etc. Other holder devices are contemplated and are within the scope of the description and claims.

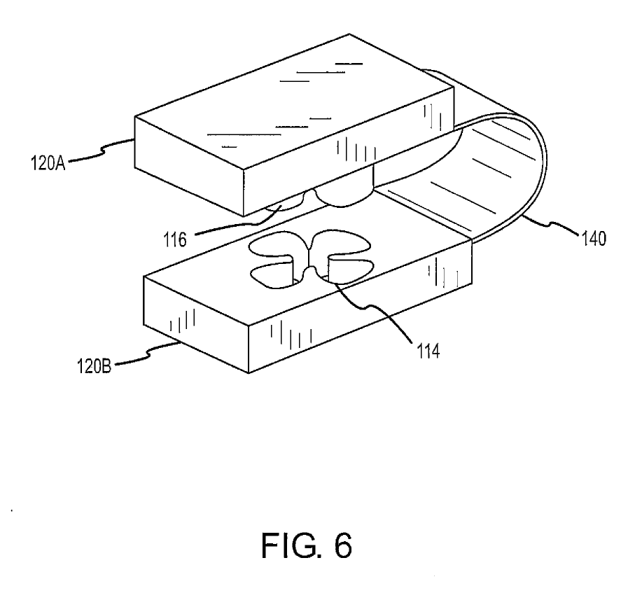

FIG. 6 shows the removable projection insert 120A and the removable depression insert 120B according to an embodiment of the invention. In this embodiment the removable projection insert 120A and the removable depression insert 120B include a joiner member 140. The joiner member 140 affixes the projection insert 120A to the depression insert 120B. The joiner member 140 therefore keeps the depression insert 120B from being separated from the projection insert 120A. For example, the joiner member 140 can comprise any manner of cord, wire, strap, etc.

The joiner member 140 in some embodiments can further comprise a biasing member, such as a spring. The joiner member 140 can consequently place an opening force on the first and second jaw portions 103A and 103B through the removable projection insert 120A and the removable depression insert 120B. As a result, the joiner member 140 can tend to return the first and second jaw portions 103A and 103B to an open position when the dental impression tool 100 is released by a user.

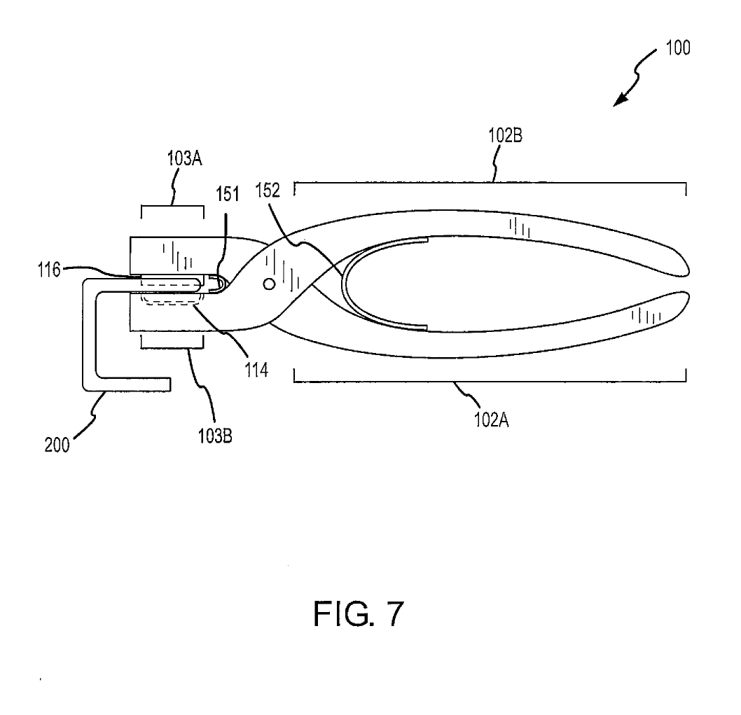

FIG. 7 shows the dental impression tool 100 according to an embodiment of the invention. In this embodiment, the dental impression tool 100 includes a biasing member 151 and/or 152. The biasing member 151 comprises a biasing member located substantially between the first jaw portion 103A and the second jaw portion 103B. The biasing member 152 comprises a biasing member located substantially between the first grip portion 102A and the second grip portion 102B. The biasing member 151 and/or 152 can be permanently or removably affixed at either location. In either location, the biasing member 151 and/or 152 is operable to move the first jaw portion 103A and the second jaw portion 103B apart in an absence of a compression force on the first and second grip portions 102A and 102B.

What is claimed is:

1. A dental impression system, comprising:
a decorative dental overlay shaped to fit over one or more teeth of a person; and
a dental impression tool for creating a decorative impression in the decorative dental overlay, the dental impression tool comprising:
a first tool portion including a first jaw portion, a first grip portion, and a first pivot aperture located between the first jaw portion and the first grip portion, the first jaw portion including a projection;
a second tool portion including a second jaw portion, a second grip portion, and a second pivot aperture located between the second jaw portion and the second grip portion, the second jaw portion including a depression that substantially matches the projection; and
a pivot member that passes through the first and second pivot apertures and pivotally affixes the first tool portion to the second tool portion.

2. The dental impression tool of claim 1, with the depression passing at least partially through the second jaw portion.

3. The dental impression tool of claim 1, with the depression passing fully through the second jaw portion.

4. The dental impression tool of claim 1, with the projection and the depression comprising a predetermined shape.

5. The dental impression tool of claim 1, with the projection and the depression comprising a predetermined size.

6. The dental impression tool of claim 1, with the projection being formed on a projection insert that removably fits to a first socket of the first jaw portion and with the depression being formed in a depression insert that removably fits to a second socket of the second jaw portion.

7. The dental impression tool of claim 1, with the projection being formed on a projection insert that removably fits to a first socket of the first jaw portion and with the depression being formed in a depression insert that removably fits to a second socket of the second jaw portion, wherein the projection insert and the depression insert are coupled by a biasing device that provides an opening force to the first and second jaw portions.

8. The dental impression tool of claim 1, further comprising a biasing member positioned between the first tool portion and the second tool portion, with the biasing member being operable to move the first jaw portion and the second jaw portion apart in an absence of a compression force on the first and second grip portions.

9. A dental impression tool adapted for use with a decorative dental overlay, the dental impression tool comprising:
a first tool portion including a first jaw portion, a first grip portion, and a first pivot aperture located between the first jaw portion and the first grip portion, the first jaw portion including a first socket;
a removable projection insert including a projection, with the projection insert being configured to fit into the first socket;
a second tool portion including a second jaw portion, a second grip portion, and a second pivot aperture located between the second jaw portion and the second grip portion, the second jaw portion including a second socket;
a removable aperture insert including a depression that substantially matches the projection, with the depression insert being configured to fit into the second socket; and
a pivot member that passes through the first and second pivot apertures and pivotally affixes the first tool portion to the second tool portion.

10. The dental impression tool of claim 9, with the depression passing at least partially through the second jaw portion.

11. The dental impression tool of claim 9, with the depression passing fully through the second jaw portion.

12. The dental impression tool of claim 9, with the projection and the depression comprising a predetermined shape.

13. The dental impression tool of claim 9, with the projection and the depression comprising a predetermined size.

14. The dental impression tool of claim 9, wherein the projection insert and the depression insert are coupled by a biasing device that provides an opening force to the first and second jaw portions.

15. The dental impression tool of claim 9, further comprising a biasing member positioned between the first tool portion and the second tool portion, with the biasing member being operable to move the first jaw portion and the second jaw portion apart in an absence of a compression force on the first and second grip portions.

16. A dental impression tool adapted for use with a decorative dental overlay, the dental impression tool comprising:
a first tool portion including a first jaw portion, a first grip portion, and a first pivot aperture located between the first jaw portion and the first grip portion, the first jaw portion including a projection;
a second tool portion including a second jaw portion, a second grip portion, and a second pivot aperture located between the second jaw portion and the second grip portion, the second jaw portion including a depression that substantially matches the projection;
a pivot member that passes through the first and second pivot apertures and pivotally affixes the first tool portion to the second tool portion; and
a biasing member positioned between the first tool portion and the second tool portion, with the biasing member being operable to move the first jaw portion and the second jaw portion apart in an absence of a compression force on the first and second grip portions.

17. The dental impression tool of claim 16, with the depression passing at least partially through the second jaw portion.

18. The dental impression tool of claim 16, with the depression passing fully through the second jaw portion.

19. The dental impression tool of claim 16, with the projection and the depression comprising a predetermined shape.

20. The dental impression tool of claim 16, with the projection and the depression comprising a predetermined size.

21. The dental impression tool of claim 16, with the projection being formed on a projection insert that removably fits to a first socket of the first jaw portion and with the depression being formed in a depression insert that removably fits to a second socket of the second jaw portion.

22. The dental impression tool of claim 16, with the projection being formed on a projection insert that removably fits to a first socket of the first jaw portion and with the depression being formed in a depression insert that removably fits to a second socket of the second jaw portion, wherein the projection insert and the depression insert are coupled by a biasing device that provides an opening force to the first and second jaw portions.

23. A method of forming a decorative impression in a decorative dental overlay, the method comprising:
placing a portion of the decorative dental overlay between a pair of jaws of a dental impression tool, with the dental impression tool including a first jaw portion and a projection formed thereon and a second jaw portion and a corresponding depression formed therein; and
compressing the portion of the decorative dental overlay between the projection and the depression without requiring heating of the decorative dental overlay, with the compressing substantially deforming the portion of the decorative dental overlay and creating the decorative impression.

24. The method of claim 23, with the projection and the depression comprising a predetermined shape.

25. The method of claim 23, with the projection and the depression comprising a predetermined size.

26. The method of claim 23, with the projection being formed on a projection insert that removably fits to a first socket of the first jaw portion and with the depression being formed in a depression insert that removably fits to a second socket of the second jaw portion.

27. The method of claim 23, with the projection being formed on a projection insert that removably fits to a first socket of the first jaw portion and with the depression being formed in a depression insert that removably fits to a second socket of the second jaw portion, wherein the projection insert and the depression insert are coupled by a biasing device that provides an opening force to the first and second jaw portions.

28. The method of claim 23, further comprising a biasing member positioned between the first tool portion and the second tool portion, with the biasing member being operable to move the first jaw portion and the second jaw portion apart in an absence of a compression force on the first and second grip portions.
